(19) United States
(12) Patent Application Publication
(10) Pub. No.: US 2025/0310413 A1
(43) Pub. Date: Oct. 2, 2025

(54) APPLYING MACHINE LEARNING TO HANDLING INTERACTIONS BETWEEN COMPUTING SYSTEMS

(71) Applicant: Truist Bank, Charlotte, NC (US)

(72) Inventor: Nishank Jain, Atlanta, GA (US)

(73) Assignee: Truist Bank, Charlotte, NC (US)

(21) Appl. No.: 18/625,269

(22) Filed: Apr. 3, 2024

Related U.S. Application Data
(63) Continuation of application No. 18/624,477, filed on Apr. 2, 2024.

(51) Int. Cl. H04L 67/50; H04L 67/306; H04L 67/53

(52) U.S. Cl. CPC H04L 67/535; H04L 67/306; H04L 67/53

(57) ABSTRACT

A system can input a set of usage data associated with an account into a machine-learning model. The set of usage data can include historical data for the account associated with interactions between computing systems. The machine-learning model can generate an output indicating a score for a pattern of behavior associated with the interactions. The system can generate, based on historical data of interactions performed by multiple accounts, an adjustment to an interaction for the account. The adjustment can be used to increase the score for the pattern of behavior. The system can provide a user interface displaying the adjustment. The system can receive, through the user interface, a selection to initiate the adjustment to perform the interaction. In response, the system can automatically configure the system to fulfil the interaction according to the adjustment.

### CROSS-REFERENCE TO RELATED APPLICATIONS

This application is a continuation of U.S. patent application Ser. No. 18/624,477 filed Apr. 2, 2024, titled “APPLYING MACHINE LEARNING TO HANDLING INTERACTION BETWEEN COMPUTING SYSTEMS,” the entirety of which is incorporated herein by reference.

### TECHNICAL FIELD

The present disclosure relates generally to handling interactions between computing systems. More specifically, but not by way of limitation, this disclosure relates to applying machine learning to handling interactions between computing systems.

### BACKGROUND

A computing system can be formed from a physical infrastructure containing a hardware router and other network hardware. The network hardware can be configured for routing requests through a network. The requests can include any requests transmitted from one or more sources via one or more networks, such as a local area network or the Internet. End users may have accounts with the computing system. The end users may interact with the computing system to monitor or perform functions using their accounts.

### BRIEF DESCRIPTION OF THE DRAWINGS

FIG. 1 is a block diagram of an example of a system for applying machine learning to handling interactions between computing systems, according to some aspects of the present disclosure.

FIG. 2 is a block diagram of another example of a system for applying machine learning to handling interactions between computing systems, according to some aspects of the present disclosure.

FIG. 3 is a flow chart of an example of applying machine learning to handling interactions between computing systems, according to some aspects of the present disclosure.

### DETAILED DESCRIPTION

Certain aspects and features of the present disclosure relate to using machine learning to generate adjustments for handling interactions between computing systems. A first computing system can perform interactions associated with an account of a user, where the account can be hosted by the first computing system. The interaction can be between the first computing system and a second computing system, which may be separate from the first computing system, such as an interaction involving a movement of resources from the account with the first computing system to another account with the second computing system. The interactions may be initiated by a user and the first computing system can collect usage data associated with the interactions for the account. This usage data can be used to generate one or more adjustments for the user with respect to their account interactions. Through a graphical user interface, the user can approve the adjustments and the first computing system can be automatically configured to perform interactions according to the adjustments.

The first computing system may generate adjustments for handling interactions for the user based on output from one or more machine-learning models. Examples of the machine-learning models can include a neural network, a Naive Bayes classifier, or a support vector machine. In some examples, a first machine-learning model can be trained with historical data to identify patterns of behavior in account interactions. The first machine-learning model may also be trained with historical data that is scored based on the computing efficiency (e.g., minimizing computing resource consumption for the first computing system performing the interactions), maximizing the amount of resources stored in or associated with the account, minimizing penalties associated with performing interactions, and the like. The first computing system can provide usage data for the user's account into the first machine-learning model, which can generate an output of a pattern of behavior and a score for the user's pattern of behavior based on the usage data collected for the account. It may be beneficial to increase the score for the pattern of behavior. Therefore, the first computing system can determine an adjustment to the pattern of behavior that may be associated with a higher score.

For example, the first computing system may include a second machine-learning model that is trained with the historical data to generate adjustments to patterns of behavior. The historical data may include user characteristics for users initiating the interactions indicated in the historical data. Examples of user characteristics can include demographic information such as age, gender, location, income range, profession, marital status, patterns of behavior in performing interactions, or any other characteristics associated with the users or their associated account interactions. The second machine-learning model may be trained to analyze differences between the pattern of the behavior of the user and historical patterns of behavior (e.g., of historical users with one or more user characteristics in common with the user) with higher scores (e.g., scores that are higher than the score for the user's pattern of behavior) to generate an adjustment for the pattern of behavior. In particular, the pattern of behavior, score, and user characteristics for the user can be provided as input to the second machine-learning model, which can generate an output indicating the adjustment. Implementing the adjustment may increase the user's score for the pattern of behavior, thus improving computational efficiency and resource management for the user and the first computing system.

For example, the first machine-learning model may produce an output indicating that the user may have a pattern of initiating a movement of resources from the account to another account with another computing system once per week. The movement of resources may be performed by a first service executed by the first computing system. The output may also indicate a score for this pattern of behavior that is relatively low (e.g., below a target threshold). To improve the score, the output from the first machine-learning model can be provided as input to the second machine-learning model, along with user characteristics for the user. The second machine-learning model can use the input to identify historical data associated with a set of historical users with similar characteristics to the user (e.g., similar income, age, location) that also perform automatic interactions once per week and have higher associated scores for such a pattern of behavior. The second machine-learning model can compare characteristics of the patterns of behavior by the set of historical users to the pattern of behavior by the user to generate an adjustment. For example, historical patterns of behavior that perform the automatic movement of resources once per week with a second service instead of a first service may be associated with higher scores. This may be because the second service can move the resources faster or more efficiently (e.g., with reduced latency) than the first service. Thus, the second machine-learning model can generate an adjustment for the user to perform an automatic movement of resources once per week with the second service. If the user approves this adjustment, the first computing system may automatically set up an interaction of an automatic movement of resources once per week from the account using the second service, such as by generating a set of rules for the account. These adjustments may be tailored to the user based on their own usage data and may provide the user with increased understanding of services executed by the first computing system. The adjustments may also provide insights for optimizing efficiency for both the user and the first computing system.

These illustrative examples are given to provide the reader with the general subject matter discussed here and are not intended to limit the scope of the disclosed concepts. The following sections describe various additional features and examples with reference to the drawings in which like numerals indicate like elements.

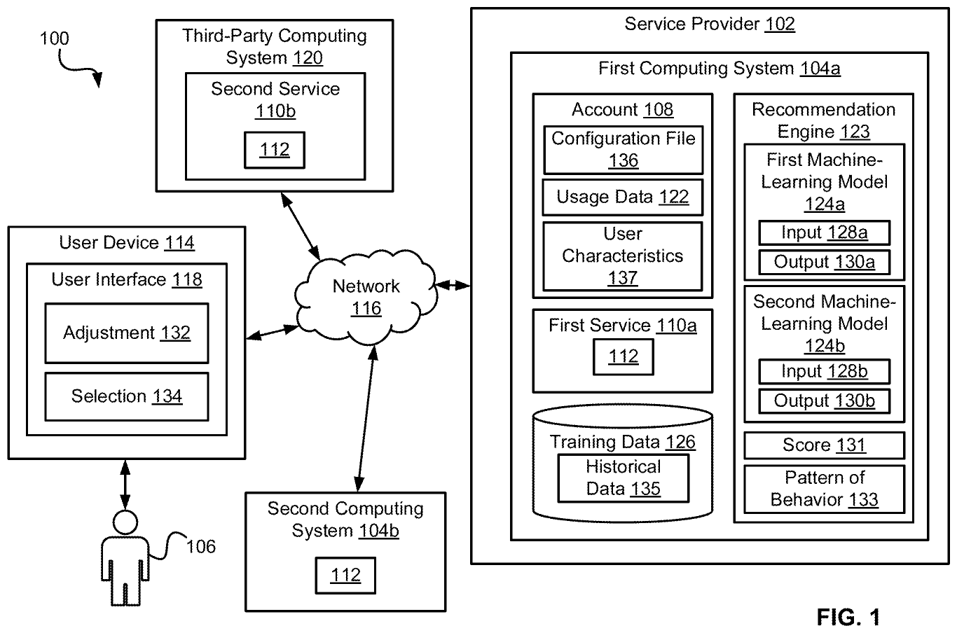

FIG. 1 is a block diagram of an example of a system 100 for applying machine learning to handling interactions 112 between computing systems 104a-b, according to some aspects of the present disclosure. The system 100 includes a service provider 102 that can operate a first computing system 104a. In some examples, the first computing system 104a may be a distributed computing system, such as a cloud computing system or a computing cluster, formed from one or more nodes (e.g., physical or virtual servers) that are in communication with one another via a network. The first computing system 104a can be formed from a physical infrastructure that includes various network hardware, such as routers, hubs, bridges, switches, and firewalls. The physical infrastructure can also include one or more servers through which a user 106 can perform account functions related to an account 108. The servers may provide backend support for a mobile application or may provide a web interface for enabling the user 106 to perform the account functions. In some examples, the servers may be part of, or otherwise interface with, a first service 110a configured to effectuate the account functions.

A user may establish an account 108 with the service provider 102 for use in performing various functions. The account 108 may be of any suitable type. The process of establishing the account 108 may require the user 106 to fill out forms for security purposes. After establishing the account 108 with the service provider 102, the user 106 may use the account 108 to perform various functions. These functions can involve interactions between the first computing system 104a and another computing system, such as second computing system 104b. For example, the user 106 may use the account 108 to perform an interaction 112 between the first computing system 104a and the second computing system 104b to obtain access to various resources, such as physical objects or virtual objects. Examples of the physical objects can include food, clothing, and electronics. Examples of the virtual objects can include software, videos, and music files. The interaction 112 may involve transmitting resources from the account 108. The user 106 may use the account 108 to perform one-time interactions or may set up repeated automatic interactions for the account 108 (e.g., interactions that are periodically performed at a particular time without being initiated by the user, such as a housing-related interaction that is transmitted on the first day of each month).

The user 106 may also provide resources to the account 108 over time. For example, the user 106 may input resources into the account 108 at periodic intervals. Alternatively, an entity that is distinct from but associated with the user 106 may provide resources to the account 108. Usage of the account 108 may result in inflows to and outflows from the account 108. The user 106 can set up the account 108 and otherwise interact with the first computing system 104a via a user device 114. Examples of the user device 114 can include a mobile phone, a laptop computer, a desktop computer, or a smart watch. The user device 114 can interact with the first computing system 104a via a network 116, such as a local area network or the Internet.

The service provider 102 can provide a user interface 118 (e.g., a graphical user interface) to the user 106 for controlling the account 108. The user 106 can access the user interface 118 by logging into the account 108. This may involve the user 106 authenticating with the first computing system 104a. For example, the user 106 can provide a username and password associated with the account 108 to the first computing system 104a. Upon authenticating the username and password, the first computing system 104a may allow the user 106 to access the user interface 118. In some examples, the user interface 118 may be part of an application (e.g., a native application) executing on the user device 114. In other examples, the user interface 118 may be part of a website accessible via a website browser. The user interface 118 may allow the user 106 to perform account functions related to the account 108 hosted by the service provider 102.

For example, the user 106 may interact with the user interface 118 to initiate an interaction 112 that is performed by a first service 110a hosted by the service provider 102. The first service 110a may be a wire service, and the interaction 112 may involve wiring resources from the account 108 to the second computing system 104b. The user 106 may interact with the user interface 118 to initiate interactions that are performed by other services as well. For example, the service provider 102 may coordinate with a second service 110b provided by a third-party computing system 120 to fulfill the interaction 112. The second service 110b can perform real-time interactions between the account 108 and the second computing system 104b. The first computing system 104a may route a request for the interaction 112 to the third-party computing system 120 to cause the second service 110b to fulfill the interaction 112.

The first computing system 104a may generate and store usage data 122 related to the account 108. The usage data 122 can include historical data describing prior usage of the account 108, such as prior interactions or other account functions initiated by the user 106. The usage data 122 may also include user characteristics 137 of the user (e.g., age, profession, marital status, location, income, and the like) and any other user activity behavior associated with the user 106 or the account 108. In some examples, the usage data 122 associated with the account 108 may be stored in various locations, as each service that executes functions associated with the account 108 may separately store usage data for that service. The first computing system 104a may compile the usage data 122 for the account 108 by accessing data from the services 110a-b, such as by executing application programming interface calls.

In some examples, the first computing system 104a may execute a recommendation engine 123 that includes trained machine-learning models 124a-b. The recommendation engine 123 can generate adjustments 132 for the user 106 with respect to the account 108 based on outputs from the machine-learning models 124a-b. Examples of the trained machine-learning models 124a-b may include a neural network or classifier. The trained machine-learning models 124a-b may go through a training process to tune weights therein prior to being deployed for use. The training process may include supervised training or unsupervised training, depending on the type of model used and the training data that is available. In some examples, the first computing system 104a may use training data 126 in the training process that includes usage histories for different accounts. In some examples, each of the trained machine-learning models 124a-bmay include one or more machine-learning models. For example, a first machine-learning model 124a may include a model that is trained to identify or categorize patterns of behavior 133 or types of users from usage data 122. The first machine-learning model 124a may also include a model that is trained to generate a score 131 for the identified pattern of behavior. The first machine-learning model 124a can be trained to generate the score 131 based on training data 126 that includes scores assigned to historical data 135. A relatively higher score may indicate a pattern of behavior that is more computationally efficient (e.g., reduces latency or resource consumption for the service provider 102).

The recommendation engine 123 can provide the usage data 122 for the account 108 as a first input 128a to the first machine-learning model 124a. The first machine-learning model 124a can generate a first output 130a indicating a pattern of behavior 133 identified for interactions with the account 108 based on the input 128 and a score 131 for the pattern of behavior 133. In some examples, the pattern of behavior 133 may involve an automatic interaction that the user 106 has set up to be automatically performed on a repeating basis (e.g., without requiring user initiation for each subsequent automatic interaction). If the score 131 is relatively low (e.g., below a threshold value), the recommendation engine 123 may automatically generate an adjustment 132 to the pattern of behavior 133 that may result in an increased score.

For example, the first machine-learning model 124a may have generated a first output 130a identifying a pattern of behavior 133 of an automatic interaction 112 between the first computing system 104a and the second computing system 104b that involves moving resources from the account 108 to another account associated with the second computing system 104b. The automatic interaction 112 may occur on the first day of each month via the first service 110a, which may be a wire service. This pattern of behavior 133 may be identified by the first machine-learning model 124a in the first output 130a as having a relatively low score 131. To improve the score 131, the recommendation engine 123 may provide the pattern of behavior 133, score 131, and user characteristics 137 as a second input 128b into a second machine-learning model 124b. The second machine-learning model 124b can compare the pattern of behavior 133 for the user 106 with historical data 135 for other users (e.g., the training data 126).

For example, the second machine-learning model 124b may identify a set of users that historically performed automatic interactions that involved the same entities or similar amounts of resources. In some examples, the set of users may also be identified based on similarities to the user 106. For example, the set of users may include users with one or more user characteristics 137 in common with the user 106 (e.g., age, income, location, etc.). From this set of users, the second machine-learning model 124b can determine differences in patterns of behavior that may be associated with higher scores. For example, automatic interactions performed with the second service 110b may be associated with higher scores than automatic interactions performed with the first service 110a. The second service 110b may be a real-time service that can execute the interaction faster compared to the first service 110a. Additionally, causing the second service 110b to execute the automatic interaction 112 instead of the first service 110a may be more computationally efficient for the first computing system 104a. This can reduce latency for the first computing system 104a.

Therefore, the second machine-learning model 124b can generate a second output 130b based on the second input 128b indicating an adjustment 132 for the user 106 to use the second service 110b. The recommendation engine 123 can output the adjustment 132 to the user via the user interface 118.

In another example, when the user 106 sets up an automatic interaction 112, the first computing system 104a may adjust a configuration file 136 for the account 108 that can dictate how the automatic interaction 112 is to be performed. For example, the configuration file 136 may dictate the size or amount of resources that are to be moved from the account 108, the repeating date on which the resources are to be moved (e.g., the first day of each month), and the service that is to execute the automatic interaction 112. This pattern of behavior 133 can be identified by the first machine-learning model 124a as having a relatively low score 131. The pattern of behavior 133 and the score 131 can be provided as second input 128b into the second machine-learning model 124b, which may determine, such as by analyzing the training data 126, that automatic interactions that are performed on different days of the month are associated with higher scores. This may be because a majority of users perform housing-related interactions on the first day of the month, resulting in high network traffic and resource strain for the service provider 102. Performing a housing-related interaction on another day of the month may result in a lower score. Therefore, the second machine-learning model 124b may generate a second output 130b indicating an adjustment 132 to the automatic date. The adjustment 132 may involve executing the automatic interaction 112 on the fifteenth day of each month instead of the first day of each month.

The first computing system 104a can transmit the adjustment 132 to the user 106 to request the user 106 to approve or deny the adjustment 132. The first computing system 104a can provide the adjustment 132 to the user 106 as part of the user interface 118. If the user 106 makes a selection 134 via the user interface 118 to approve the adjustment 132, the first computing system 104a can be automatically configured to apply the adjustment 132. For example, if the adjustment 132 involves switching from the first service 110a to the second service 110b, the first computing system 104a can update the configuration file 136 associated with executing the automatic interaction 112. The updated configuration file 136 can dictate that subsequent automatic interactions 112 will be fulfilled by automatically routing the interaction 112 to the third-party computing system 120 to cause the second service 110b to execute the automatic interaction 112. If the adjustment 132 involves changing a repeating date for the automatic interaction 112, the first computing system 104a can update the configuration file 136 to dictate that the automatic interaction 112 is to be executed on the recommended date on a repeating basis.

Although FIG. 1 depicts a certain number and arrangement of components, this is for illustrative purposes and is intended to be non-limiting. Other examples may include more components, fewer components, different components, or a different arrangement of the components shown in FIG. 1. For example, although FIG. 1 involves routing requests using two different services, other examples may involve a larger number of services or computing systems and more complex routing schemes.

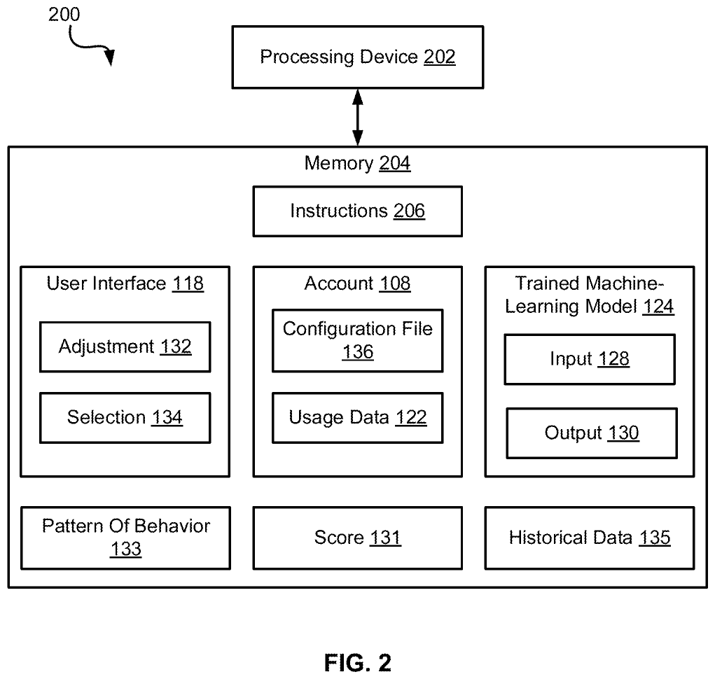

FIG. 2 is a block diagram of another example of a system for applying machine learning to handling interactions between computing systems, according to some aspects of the present disclosure. The system 200 includes a processing device 202 that is communicatively coupled to a memory 204. In some examples, the processing device 202 and the memory 204 may be distributed from (e.g., remote to) one another.

The processing device 202 can include one processing device or multiple processing devices. Non-limiting examples of the processing device 202 include a Field-Programmable Gate Array (FPGA), an application-specific integrated circuit (ASIC), a microprocessor, etc. The processing device 202 can execute instructions 206 stored in the memory 204 to perform operations. In some examples, the instructions 206 can include processor-specific instructions generated by a compiler or an interpreter from code written in a suitable computer-programming language, such as C, C++, C #, etc.

The memory 204 can include one memory or multiple memories. The memory 204 can be non-volatile and may include any type of memory that retains stored information when powered off. Non-limiting examples of the memory 204 include electrically erasable and programmable read-only memory (EEPROM), flash memory, or any other type of non-volatile memory. At least some of the memory 204 can include a non-transitory, computer-readable medium from which the processing device 202 can read instructions 206. A computer-readable medium can include electronic, optical, magnetic, or other storage devices capable of providing the processing device 202 with computer-readable instructions or other program codes. Non-limiting examples of a computer-readable medium include magnetic disk(s), memory chip(s), ROM, random-access memory (RAM), an ASIC, a configured processor, optical storage, or any other medium from which a computer processor can read the instructions 206.

The system 200 may also include other input and output (I/O) components, which are not shown here for simplicity. Examples of such input components can include a mouse, a keyboard, a trackball, a touch pad, and a touch-screen display. Examples of such output components can include a visual display, an audio display, and a haptic display. Examples of a visual display can include a liquid crystal display (LCD), a light-emitting diode (LED) display, and a touch-screen display. An example of an audio display can include speakers. An example of a haptic display may include a piezoelectric vibration device or an eccentric rotating mass (ERM) device.

The memory 204 can include one or more trained machine-learning models 124 (e.g., the first machine-learning model 124a and the second machine-learning model 124b) configured to analyze interactions 112 between computing systems. The one or more trained machine-learning models 124 can generate an output 130 indicating a score 131 for a pattern of behavior 133 identified from usage data 122 collected for an account 108 associated with a user. The memory 204 may include instructions 206 that can be executed by the processing device 202 to generate an adjustment 132 to an interaction associated with the account 108 based on historical data 135. The adjustment 132 may increase the score 131 for the pattern of behavior 133. The memory 204 can also include a user interface 118 that can display the adjustment 132 to a user 106. A selection 134 approving the adjustment 132 can be received via the user interface 118. In response, the processing device 202 can configure the system 200 to fulfill the interaction 112 according to the adjustment 132.

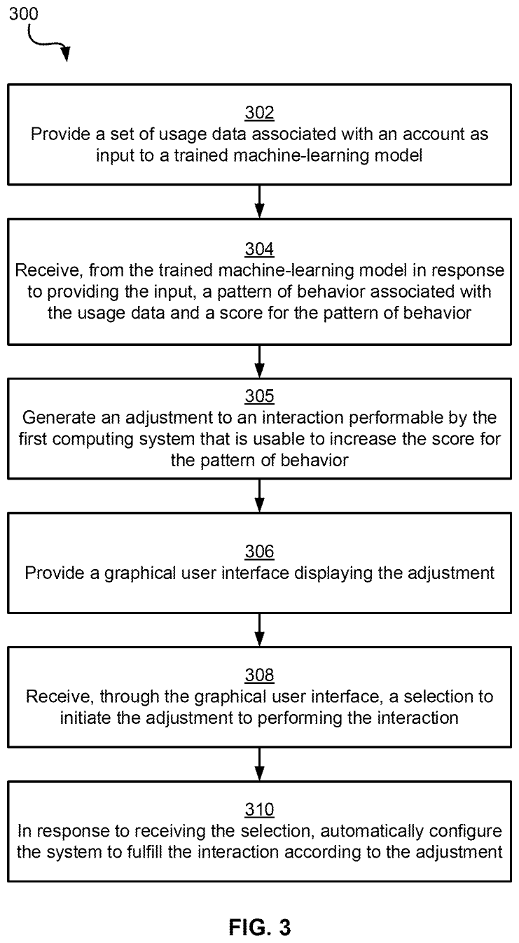

Turning now to FIG. 3, shown is a flow chart of an example of a process 300 for applying machine learning to handling interactions between computing systems, according to some aspects of the present disclosure. Other examples can include more operations, fewer operations, different operations, or a different order of operations shown in the figures. The operations of FIG. 3 will now be described below with reference to the components described above in FIGS. 1-2. Some or all of the steps of the process 300 can be performed by the processing device 202.

At block 302, the processing device 202 can provide a set of usage data 122 associated with an account 108 of a user 106 as input 128 to a first machine-learning model 124a. The set of usage data 122 can include historical data associated with interactions between a first computing system 104a associated with the account 108 and a second computing system 104b. The first machine-learning model 124a may be trained based on a set of training data 126 that includes usage data for multiple accounts. The training data 125 may include scores for patterns of behavior of historical usage data. The first machine-learning model 124a can be configured to generate a first output 130a identifying a pattern of behavior 133 from the usage data 122. The first machine-learning model 124a can also generate a first output 130a of a score 131 for the pattern of behavior 133. The score 131 may indicate a resource strain involved in performing the interactions associated with the pattern of behavior 133. In some examples, the first machine-learning model 124a may output multiple patterns of behavior and associated scores. The processing device 202 may identify one or more of the patterns of behavior as having a score that is below a target threshold. Adjustments can therefore be generated for such patterns of behavior. For example, the first machine-learning model 124a may generate first output 130a indicating that the user 106 has a pattern of making multiple resource retrievals from the account 108 per month via the first service 110a and an associated score 131 that is below the target threshold.

At block 304, the processing device 202 can receive, from the first machine-learning model 124a in response to providing the first input 128a, the pattern of behavior 133 and the score 131. The pattern of behavior 133 and the score 131 can be indicated in the first output 130a.

At block 305, the processing device 202 can generate an adjustment 132 to an interaction 112 performed by the first computing system. Applying the adjustment 132 may increase the score 131 for the pattern of behavior 133. The processing device 202 can generate the adjustment 132 based on historical data 135 of usage data from multiple users and their associated interactions. The processing device 202 can identify, from the historical data, users with similar patterns of behavior but higher scores (e.g., higher than the score 131 for the pattern of behavior 133 identified from the usage data 122). In some examples, the second machine-learning model 124b can be executed to identify the patterns of behavior with higher scores in the historical data 135. The processing device 202 can compare the higher-scoring patterns of behavior to the user's pattern of behavior 133 to generate the adjustment 132. In some examples, the adjustment 132 may be determined using a second machine-learning model 124b.

For example, the processing device 202 may provide the output 130 from the first machine-learning model 124a as second input 128b to the second machine-learning model 124b. The second machine-learning model 124b may determine from the historical data 135 that interactions involving a single resource retrieval over a month are associated with lower scores than interactions that involve multiple, smaller resource retrievals over the month. The second machine-learning model 124b can generate a second output 130b based on the second input 128b that indicates an adjustment 132 that may involve performing a single interaction 112 via the first service 110a per month. The single interaction 112 may combine the multiple resource retrievals into a single resource retrieval. Executing a single interaction 112 may consume less computing resources than performing multiple individual interactions. To confirm that such an adjustment 132 may be beneficial, the processing device 202 can input the adjustment 132 with the usage data 122 into the trained machine-learning model 124. The trained machine-learning model 124 can output a second score for the adjustment 132, and if the second score is higher than the first score determined solely from the usage data 122, the processing device 202 may output the adjustment 132 to the user 106.

At block 306, the processing device 202 can provide a graphical user interface 118 displaying the adjustment 132 to the user 106. The graphical user interface 118 can be output to a user device 114. The adjustment 132 can be displayed as part of an application or a webpage associated with the service provider 102. For example, the graphical user interface 118 may provide an option for the user 106 to set up an automatic repeating interaction of a single resource retrieval once per month for an amount that covers the amount of resources previously retrieved by the user 106 over a period of a month.

At block 308, the processing device 202 can receive, through the graphical user interface 118, a selection 134 from the user 106 to initiate the adjustment 132 to perform the interaction 112. The user 106 may select the option to set up the automatic interaction of a single resource retrieval. The user device 114 can transmit the selection 134 to the processing device 202.

At block 310, the processing device 202 can automatically configure the first computing system 104a to fulfill the interaction 112 according to the adjustment 132 in response to receiving the selection 134 from the user 106. For example, the processing device 202 can configure the first computing system 104a to automatically execute the single interaction 112 using the first service 110a at a repeating time (e.g., once a month). Setting up this repeating, single, and automatic interaction 112 can allow the user 106 to forgo manually initiating multiple individual interactions.

The above description of certain examples, including illustrated examples, has been presented only for the purpose of illustration and description and is not intended to be exhaustive or to limit the disclosure to the precise forms disclosed. Modifications, adaptations, and uses thereof will be apparent to those skilled in the art without departing from the scope of the disclosure. For instance, any examples described herein can be combined with any other examples.

W hat is claimed is:

1. A system comprising:
a processing device; and
a memory including instructions that are executable by the processing device for causing the processing device to:
generate, by executing a first trained machine-learning model and based on a first input comprising a set of usage data associated with an account, a first output indicating a pattern of behavior associated with the set of usage data and a score for the pattern of behavior, the set of usage data including historical data associated with interactions between a first computing system associated with the account and a second computing system;
generate, by executing a second machine-learning model and based on a second input comprising the pattern of behavior and the score, a second output comprising an adjustment to an interaction performable by the first computing system, the adjustment to the interaction being usable to increase the score for the pattern of behavior; and
automatically configure the first computing system to fulfill the interaction according to the adjustment.

2. The system of claim 1, wherein the first computing system is configured to execute the interaction via a first service prior to generating the adjustment, wherein the adjustment comprises adjusting the interaction to be routed to a second service to execute the interaction, the second service being different from the first service and executed by a third-party computing system, and wherein the memory further includes instructions that are executable by the processing device for causing the processing device to automatically configure the first computing system to fulfill the interaction by:
adjusting a configuration file for the account such that a subsequent interaction is automatically routed to the third-party computing system to be executed by the second service.

3. The system of claim 2, wherein the first service is a wire service, and wherein the second service is a real-time service.

4. The system of claim 1, wherein the pattern of behavior is an automatic interaction that is repeated, wherein the account comprises a configuration file dictating that the automatic interaction is executed on a first repeating date, wherein the adjustment comprises executing the automatic interaction on a second repeating date that is different than the first repeating date, and wherein the memory further includes instructions that are executable by the processing device for causing the processing device to automatically configure the first computing system to execute the automatic interaction by:
adjusting the configuration file for the account to cause the automatic interaction to be executed on the second repeating date.

5. The system of claim 1, wherein the set of usage data includes historical data relating to a plurality of interactions executed by a particular service, wherein the adjustment comprises performing a single interaction with the particular service that combines the plurality of interactions, and wherein the memory further includes instructions that are executable by the processing device for causing the processing device to automatically configure the first computing system to fulfill the interaction by:
configuring the particular service to automatically execute the single interaction at a particular repeating time.

6. The system of claim 1, wherein the second trained machine-learning model is configured to generate the second output comprising the adjustment to the pattern of behavior by comparing the pattern of behavior and the score to historical data, the historical data comprising historical patterns of behavior and historical scores.

7. The system of claim 1, wherein the set of usage data includes user characteristics of a user associated with the account.

8. A method comprising:
generating, by a processing device executing a first trained machine-learning model and based on a first input comprising a set of usage data associated with an account, a first output indicating a pattern of behavior associated with the set of usage data and a score for the pattern of behavior, the set of usage data including historical data associated with interactions between a first computing system associated with the account and a second computing system;
generating, by the processing device executing a second trained machine-learning model and based on a second input comprising the pattern of behavior and the score, a second output comprising an adjustment to an interaction performable by the first computing system, the adjustment to the interaction being usable to increase the score for the pattern of behavior; and
automatically configuring, by the processing device, the first computing system to fulfill the interaction according to the adjustment.

9. The method of claim 8, wherein the first computing system is configured to execute the interaction via a first service prior to generating the adjustment, wherein the adjustment comprises adjusting the interaction to be routed to a second service to execute the interaction, the second service being different from the first service and executed by a third-party computing system, and wherein the method further comprises automatically configuring the first computing system to fulfill the interaction by:
adjusting a configuration file for the account such that a subsequent interaction is automatically routed to the third-party computing system to be executed by the second service.

10. The method of claim 9, wherein the first service is a wire service, and wherein the second service is a real-time service.

11. The method of claim 8, wherein the pattern of behavior is an automatic interaction that is repeated, wherein the account comprises a configuration file dictating that the automatic interaction is executed on a first repeating date, wherein the adjustment comprises executing the automatic interaction on a second repeating date that is different than the first repeating date, and wherein the method further comprises automatically configuring the first computing system to execute the automatic interaction by:
adjusting the configuration file for the account to cause the automatic interaction to be executed on the second repeating date.

12. The method of claim 8, wherein the set of usage data includes historical data relating to a plurality of interactions executed by a particular service, wherein the adjustment comprises performing a single interaction with the particular service that combines the plurality of interactions, and wherein the method further comprises automatically configuring the first computing system to fulfill the interaction by:
configuring the particular service to automatically execute the single interaction at a particular repeating time.

13. The method of claim 8, wherein the second trained machine-learning model is configured to generate the second output comprising the adjustment to the pattern of behavior by comparing the pattern of behavior and the score to historical data, the historical data comprising historical patterns of behavior and historical scores.

14. The method of claim 8, wherein the set of usage data includes user characteristics of a user associated with the account.

15. A non-transitory computer-readable medium comprising program code that is executable by a processing device for causing the processing device to:
generate, by executing a first trained machine-learning model and based on a first input comprising a set of usage data associated with an account, a first output indicating a pattern of behavior associated with the set of usage data and a score for the pattern of behavior, the set of usage data including historical data associated with interactions between a first computing system associated with the account and a second computing system;
generate, by executing a second machine-learning model and based at on a second input comprising the pattern of behavior and the score, a second output comprising an adjustment to an interaction performable by the first computing system, the adjustment to the interaction being usable to increase the score for the pattern of behavior; and
automatically configure the first computing system to fulfill the interaction according to the adjustment.

16. The non-transitory computer-readable medium of claim 15, wherein the first computing system is configured to execute the interaction via a first service prior to generating the adjustment, wherein the adjustment comprises adjusting the interaction to be routed to a second service to execute the interaction, the second service being different from the first service and executed by a third-party computing system, and wherein the program code is further executable by the processing device for causing the processing device to automatically configure the first computing system to fulfill the interaction by:
adjusting a configuration file for the account such that a subsequent interaction is automatically routed to the third-party computing system to be executed by the second service.

17. The non-transitory computer-readable medium of claim 16, wherein the first service is a wire service, and wherein the second service is a real-time service.

18. The non-transitory computer-readable medium of claim 15, wherein the pattern of behavior is an automatic interaction that is repeated, wherein the account comprises a configuration file dictating that the automatic interaction is executed on a first repeated date, wherein the adjustment comprises executing the automatic interaction on a second repeating date that is different than the first repeating date, and wherein the program code is further executable by the processing device for causing the processing device to automatically configure the first computing system to execute the automatic interaction by:
adjusting the configuration file for the account to cause the automatic interaction to be executed on the second repeating date.

19. The non-transitory computer-readable medium of claim 15, wherein the set of usage data includes historical data relating to a plurality of interactions executed by a particular service, wherein the adjustment comprises performing a single interaction with the particular service that combines the plurality of interactions, and wherein the program code is further executable by the processing device for causing the processing device to automatically configure the first computer system to fulfill the interaction by:
configuring the particular service to automatically execute the single interaction at a particular repeating time.

20. The non-transitory computer-readable medium of claim 15, wherein the second trained machine-learning model is configured to generate the second output comprising the adjustment to the pattern of behavior by comparing the pattern of behavior and the score to historical data, the historical data comprising historical patterns of behavior and historical scores.
